(19) United States
(12) Patent Application Publication
(10) Pub. No.: US 2011/0151176 A1
(43) Pub. Date: Jun. 23, 2011

(54) METHOD OF MANUFACTURING WAFER LAMINATED BODY, DEVICE OF MANUFACTURING WAFER LAMINATED BODY, WAFER LAMINATED BODY, METHOD OF PEELING SUPPORT BODY, AND METHOD OF MANUFACTURING WAFER

(76) Inventors: Ryota Akiyama, Tokyo (JP); Shinya Nakajima, Tokyo (JP); Kazuta Saito, Tokyo (JP)

(21) Appl. No.: 13/059,113

(22) PCT Filed: Aug. 27, 2009
(86) PCT No.: PCT/US09/55142

§ 371 Date: Feb. 15, 2011

(30) Foreign Application Priority Data
Sep. 2, 2008 (JP) 2008-225231

(51) Int. Cl. B32B 7/12; B32B 37/06; B32B 37/02; B32B 38/10

(52) U.S. Cl. 428/78; 156/272.2; 156/380.9; 156/701

(57) ABSTRACT

The present disclosure is to provide a method of manufacturing a wafer laminated body, a device for manufacturing a wafer laminated body, a wafer laminated body, a method of peeling a support body, and a method for manufacturing a wafer, all of which are capable of improving the grinding characteristic of the reverse surface of a wafer. A method includes sucking a wafer (2) onto a wafer suction table situated above, sucking a support body (3) onto a support body suction table situated below, and arranging the wafer (2) and the support body (3) in opposition to each other in a vertical direction; applying a liquid adhesive resin to an opposing face of the support body (3) opposed to the wafer (2) for forming a adhesive agent layer; causing the wafer (2) and the support body (3) to approach each other while maintaining parallelism therebetween, and applying pressure to the adhesive resin interposed therebetween and spreading the adhesive resin to thereby fill a space between the wafer (2) and the support body (3) with the adhesive resin, and to form a resin projecting portion (4a) on the outer circumference of the wafer

### TECHNICAL FIELD

The present disclosure relates to a method of manufacturing a wafer laminated body having a wafer and a support body adhered to each other via an adhesive agent, to a device for manufacturing a wafer laminated body, to a wafer laminated body, to a method of peeling a support body, and to a method of manufacturing a wafer.

### BACKGROUND

In general, when a semiconductor chip, the thickness of which is reduced, is manufactured, the reverse side of a semiconductor wafer, on which a circuit pattern and electrodes are formed, is ground so that the semiconductor wafer can be worked into an individual chip of a final shape. It is conventional that the circuit face side of the semiconductor wafer is held by a protective tape and then the reverse side is ground. However, since a protruding and recessing structure, the height of which is several 10 μm, is formed on the circuit face in some cases, the protective tape can not absorb the protruding and recessing structure and a circuit pattern is transferred onto the reverse side of the semiconductor wafer. In this case, stress is concentrated on the protruding portion and the semiconductor wafer is cracked. In order to solve the above problems, such a countermeasure is taken that an adhesive layer of the protective tape is made thick or a base material is made thick or formed into a multiple layer structure. The above countermeasures are somewhat effective. However, in the case of a wafer having a protruding electrode, the height of which is not less than 100 μm, which is referred to as a high bump, it is difficult for the protective tape to absorb the protruding and recessing portions formed on the circuit face. Further, sometimes, the protective tape itself deviates by 10 μm in thickness. In this case, the same thickness deviation affects the wafer.

As one conventional example in order to solve the above problems, a method is proposed in JP2004-064040, in which a highly rigid protective base material such as a glass base material or metallic base material is made to adhere onto a semiconductor wafer by using liquid adhesive. Since the liquid adhesive is used, it is possible to completely absorb the protruding and recessing portions on the semiconductor wafer surface. Since the semiconductor wafer can be protected by the highly rigid protective base material, it is possible to solve such a problem that the circuit pattern of the semiconductor wafer is transferred at the time of grinding the reverse side or such a problem that the semiconductor wafer is cracked.

Another conventional example, in which the protective base material is made to adhere onto the semiconductor wafer through adhesive, is disclosed in JP2002-203827. In this manufacturing method of the conventional example, the following descriptions are made. In the paragraph [0009] of JP2004-064040, “A coating solution for forming a coat is applied so that protruding and recessing portions can be embedded in the coat. A surface of the coating solution is made to be a coat. The breaking elongation of the coat is 30 to 700% and the breaking stress is 1.0×10⁷ to 5.0×10⁷ Pa.” Concerning the matter of smoothing the coating solution, the following descriptions are made in the paragraph [0026]. “In order to smooth the surface of the coating solution, for example, as shown in FIG. 2, it is possible to smooth the surface of the coating solution in such a manner that a smooth surface plate member 4 such as a glass plate is made to adhere onto a surface of the coating solution for forming a coat”. In order to harden the coating solution, the following descriptions are made in the paragraph [0028]. “In the case of using a plate-shaped member 4 as shown in FIG. 2, when an energy ray hardening type resin is used as a hardening resin for forming a coating solution 2 for forming a coat, energy rays are irradiated from the plate member 4 side so as to form the coating solution 2 for forming the coat into the coat.”

### SUMMARY

However, with the method, in which the glass base material or the metallic base material is adhered onto a semiconductor wafer by using an adhesive agent, there is a problem that it is difficult to peel off the glass base material or the metallic base material from the highly rigid semiconductor wafer, thickness of which is reduced by grinding the reverse surface of the semiconductor wafer. Therefore, a method has been proposed in which a release layer is provided beforehand on the protective base material, and laser peeling is carried out. However, since a complicated device is required, there is a continuing need for a simple method.

In one aspect, the present disclosure provides a method of manufacturing a wafer laminated body, a device for manufacturing a wafer laminated body, a wafer laminated body, a method of peeling a support body, and a method for manufacturing a wafer, all of which are capable of improving the grinding characteristic of the reverse surface of a wafer.

In another aspect, the present disclosure provides a method of manufacturing a wafer laminated body, a device for manufacturing a wafer laminated body, a wafer laminated body, a method of peeling a support body, and a method for manufacturing a wafer, which permits a support body and an adhesive agent layer to be easily peeled off after grinding the reverse surface of a wafer.

In order to solve the above problems, in one embodiment the present disclosure provides a method of manufacturing a wafer laminated body, the wafer laminated body comprising: a) a wafer; b) a support body for supporting the wafer; c) an adhesive agent layer for adhering the wafer and the support body; d) a resin projecting portion formed on outer circumference of side wall of the wafer; the method comprising the steps of: (1) sucking the wafer onto a wafer suction table situated above, sucking the support body onto a support body suction table situated below, and arranging the wafer and the support body in opposition to each other in a vertical direction; (2) applying a liquid adhesive resin to the opposing face of the support body opposed to the wafer for forming the adhesive agent layer; (3) causing the wafer and the support body to approach each other while maintaining parallelism between them, and applying pressure with the adhesive resin interposed between them and spreading the adhesive resin to thereby fill the space between the wafer and the support body with the adhesive resin, and to form the resin projecting portion on outer circumference of side wall of the wafer; and (4) irradiating the adhesive resin with ultraviolet ray when the wafer laminated body reaches to a predetermined thickness to thereby harden the adhesive resin and form the adhesive agent layer.

With this manufacturing method, cracking of the wafer and chipping at the edge of the wafer at the time of grinding the reverse surface can substantially be avoided, and a wafer laminated body having excellent grinding characteristic of the reverse surface of the wafer can be manufactured. Because surface irregularities of the wafer can be absorbed by the adhesive agent layer, cracking of the wafer at the time of grinding the reverse surface of the wafer can be substantially prevented.

Another aspect of the present disclosure provides a device for manufacturing a wafer laminated body comprising: a wafer suction table for sucking a wafer; a support body suction table arranged under the lower side of and in opposition to the wafer suction table, for vacuum sucking of a support body that is to be attached to the wafer via a liquid adhesive agent; and a UV irradiation source for irradiating the adhesive resin with ultraviolet ray for hardening the adhesive resin; wherein the support body suction table can transmit the ultraviolet ray and has surface irregularities in order to be able to suck the support body.

With this manufacturing device, a wafer laminated body having excellent grinding characteristic of the reverse surface of the wafer can be manufactured.

Still another aspect of the present disclosure provides a wafer laminated body comprising: a wafer; a support body that supports the wafer; an adhesive agent layer that adheres the wafer to the support body; and a resin projecting portion formed on outer circumference of side wall of the wafer.

With this wafer laminated body, surface irregularities of the wafer can be absorbed by the adhesive agent layer, so that cracking of the wafer at the time of grinding the reverse surface of the wafer can be substantially prevented.

Still another aspect of the present disclosure provides a method of peeling a support body in which, after reverse surface of the wafer laminated body according to claim 10 or 11 has been ground to reduce the thickness of the wafer to a predetermined thickness, the support body together with the adhesive agent layer is peeled off from the wafer laminated body, wherein the support body together with the adhesive agent layer is peeled off from the wafer laminated body in such a manner that, when the support body is folded back in a substantially U-shape, the wafer is not bent.

With this method of peeling a support body, after grinding of reverse surface of a wafer has been completed, the support body together with the adhesive agent layer can be peeled from the wafer without using a complicated device and without producing peeling failure in the wafer.

Still another aspect of the present disclosure provides a method of manufacturing a wafer comprising the steps of: providing a wafer laminated body; grinding the wafer to a desired thickness; and peeling off a support body from a wafer laminated body together with an adhesive agent layer after the completion of grinding.

With this method of manufacturing a wafer, damages of wafer at the time of grinding and damages of wafer at the time of peeling can be substantially avoided, so that a thin wafer as a final product can be successfully obtained from a wafer laminated body as an intermediate product.

### BRIEF DESCRIPTION OF THE DRAWINGS

FIG. 1 is a sectional view of an embodiment of the wafer lamination body of the present disclosure.

FIG. 2 is a schematic illustration for explaining circumstances in which a resin film is peeled off from a wafer lamination body.

FIG. 3 is a front view of an embodiment of the manufacturing device of manufacturing a wafer lamination body of the present disclosure.

FIGS. 4a through 4e are schematic illustrations showing a method of manufacturing a wafer lamination body of the present disclosure.

FIG. 5 is an enlarged view of portion A shown in FIG. 4b.

FIG. 6 is a front view showing a variation of the manufacturing device of manufacturing a wafer lamination body.

FIGS. 7a through 7f are schematic illustrations showing a method of manufacturing a wafer lamination body in which the manufacturing device shown in FIG. 6 is used.

### DETAILED DESCRIPTION

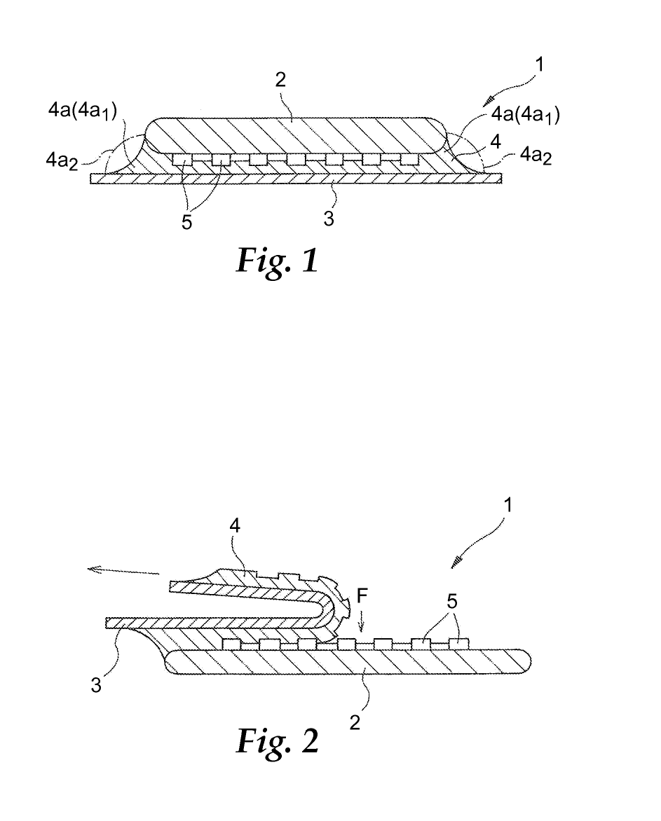

The present disclosure will be described in detail below with reference to drawings showing specific example of embodiments thereof. FIG. 1 is a view showing an embodiment of the wafer laminated body according to the present disclosure.

A wafer laminated body 1 of the present embodiment has a multi-layer structure. The wafer laminated body 1 comprises: a wafer 2 with a front surface having a circuit pattern 5 as an adhering face and with a reverse surface as a grinding face; a resin film (support body) 3 which protects the circuit pattern 5 and is to be peeled off from the adhering face after the completion of grinding of the reverse surface; and an adhesive agent layer 4 which adheres the wafer 2 to the resin film 3. A resin projecting portion 4a is formed on the outer circumference of the adhesive agent layer 4 so as to project out from the wafer 2. The resin film 3 together with the adhesive agent layer 4 is to be peeled off from the wafer 2 after completion of grinding of the reverse surface of the wafer 2. In the present embodiment, the resin film 3 and the adhesive agent layer 4 are respectively formed as single layer. However, it is also possible to form the resin film 3 and the adhesive agent layer 4 as multiple layers, respectively.

The wafer 2 can be a semiconductor wafer made of silicon, gallium or arsenic, the thickness of which can be expected to be not more than 100 μm. A surface of the wafer, on which the circuit pattern is provided, is protruded and recessed. However, when the adhesive agent enters the recessed portions, the surface of the wafer 2 can be flattened.

The liquid adhesive agent 4 is a hardening type adhesive agent, a hot-melt adhesive agent or wax, the viscosity of which is not less than 100 cP and lower than 10000 cP when the viscosity is measured by the Brookfield type viscometer at 23° C. before hardening. The reason why the viscosity is determined as described above will be explained as follows. In the case where the viscosity is lower than 100 cP, it is difficult to control the thickness of the adhesive agent 4. In the case where the viscosity is not less than 10000 cP, it is difficult for the adhesive agent 4 to spread on the protruding and recessing face of the wafer 2, that is, it is difficult for the adhesive agent 4 to enter the recessing portions. In the case of a thermo-setting type adhesive agent or a heat-melting type adhesive agent, no problems are caused when the viscosity is lower than 10000 cP at the heat-melting temperature. However, when consideration is given to the hardening time (solidifying time) and the change in the size of the device caused by heating, a light hardening type adhesive agent, which is hardened in a short period of time, is preferably used, for example, an ultraviolet ray hardening type adhesive agent is preferably used. In the case where the ultraviolet ray hardening type adhesive agent is used for the liquid adhesive agent 4, it is important that the resin film 3 has an ultraviolet ray transmitting property.

In this connection, the ultraviolet ray hardening type adhesive agent is hardened when it is irradiated with energy rays such as heat rays or ultraviolet rays. Common examples of the ultraviolet ray hardening type adhesive agent are acrylic monomer and epoxy resin. Thickness of the adhesive agent 4 for making the wafer 2 and the film 3 adhere to each other is determined so that it can absorb the thickness of the wafer 2, however, it is typical that the thickness of the adhesive agent 4 is 10-150 μm. It is preferable that the thickness of the adhesive agent 4 is 20-100 μm.

A conventional example, in which the support body adheres to the semiconductor wafer 2 through the adhesive agent, is disclosed in JP2004-064040. In JP2004-064040, the following descriptions are made. “A coating solution for forming a coat is applied so that protruding and recessing portions can be embedded in the coat. A surface of the coating solution is made to be a coat. The breaking elongation of the coat is 30 to 700% and the breaking stress is 1.0×10⁷ to 5.0×10⁷ Pa.” On the other hand, the following explanations are made into the adhesive agent 4 of the present disclosure.

(1) In order to prevent the generation of a shift and deformation by the adhesive agent 4 at the time of polishing (grinding) the reverse face, it is preferable that the breaking elongation is not more than 50% and it is more preferable that the breaking elongation is not more than 30% when a dumbbell-shaped No. 3 test piece, as described in test method JIS K 6251-1993, is tensed at 23° C.

(2) In order to reduce a failure of separation caused by a mechanical anchor force (anchor effect) generated by the adhesive agent 4 on the protruding and recessing face at the time of separating the resign film 3 and the adhesive agent 4, it is preferable that the breaking elongation is not more than 5%.

(3) In order to peel the film 3 and the adhesive agent 4 by a weak peeling force at the time of peeling and further in order to prevent the adhesive agent 4 from being broken, it is necessary that the adhesive agent is appropriately strong and flexible. It is preferable that the tensile elastic modulus of the adhesive agent after hardening is 1.0 to 9.0×10⁸ Pa at 23° C. when the tensile elastic modulus is measured by a RSAII type dynamic viscometer manufactured by Leometrix Co. The tensile elastic modulus shows a degree of the limit of elasticity. Therefore, the tensile elastic modulus is used for properly evaluating the elasticity. An example of the adhesive agent 4 having an excellent separation performance is LC3000 series, which is put on the market by Sumitomo 3M Co., Ltd. When the elastic modulus is too low, the adhesive agent becomes sticky and it becomes impossible to expect an excellent peeling property and further there is a possibility that the adhesive agent is broken at the time of peeling. When elastic modulus is too high, in the same manner as that described above, the adhesive agent tends to partially remain on the surface to be made to adhere.

In JP2004-064040, the physical property of the adhesive agent, the breaking elongation of which is 30 to 700% and the breaking stress of which is 1.0×10⁷ to 5.0×10⁷ Pa, is expected. Therefore, it is impossible to expect an excellent grinding property. At the time of peeling the adhesive layer, a stress relaxation of the adhesive agent is caused and it becomes impossible to concentrate stress upon a peeling interface. As a result, the peeling force is increased and it is impossible to expect an excellent separation.

In order to prevent the occurrence of warp of the wafer 2 at the time of grinding the reverse face so as to execute grinding without generating deformation, it is preferable that the resin film 3 has an appropriately high rigidity. Further, it is preferable that the resin film 3 can be easily peeled off after the completion of grinding the reverse face. It can be considered that the resin film 3 is subjected to the processes of frictional heating, vapor-depositing, spattering, plating and etching at the time of grinding the reverse face. Therefore, according to the process condition, a support body having a transparent property, a heat resistance property, a chemical resistance property and a low expansion ratio is preferably selected. From the viewpoint of grinding the reverse face without generating deformation, it is preferable that the resin film 3 has a bending elastic modulus of 1000 MPa and more at 23° C. In this case, the bending elastic modulus can be measured according to test method JIS K 7171-1994. As shown in FIG. 2, from the viewpoint of curving the film 3 after the completion of grinding the reverse face so as to easily peel off, the bending elastic modulus of the resin film 3 is preferably not more than 10000 MPa at 23° C. In this case, the bending elastic modulus is stipulated in JIS K 7171-1994. Thickness of the resin film 3 is preferably 30 μm to 200 μm. Examples of the useful film include a polyester film, such as polyethylene terephthalate or polyethylene naphthalate; polyolefine and polyolefine copolymer film, such as polypropylene polyethylene or polymethyl pentane; polyamide film; and acrylonitrile film. In order to peel off the resin film 3 together with the adhesive agent 4 at the time of peeling after the completion grinding the reverse face, the resin film 3 may be coated with a primer layer or an adhesive agent layer. Alternatively, the resin film 3 may be subjected to surface treatment such as corona treatment. Examples of the primer to be used are: urethane primer, rubber primer or polyester primer. In some cases, an acrylic adhesive agent or a rubber adhesive agent is coated. Except for coating a primer or an adhesive agent, it is possible to execute surface mat treatment, plasma treatment, chemical etching or flame treatment. In order to suppress the problem caused when the film 3 is warped, the film can be composed of a multi-layer structure and it is possible to use a multi-layer film containing a plurality of buffer layers. In the case where a multi-layer resin film 3 is used, it is preferable that all the layers are made of the resin material of the same quality. It is preferable that the bending elastic modulus at the room temperature 23° C. of each layer is not less than 1000 MPa and not more than 10000 MPa. The total thickness of the multi-layer structure resin film 3 is set at 30 to 200 μm.

After the reverse face of the wafer lamination body 1 has been ground, the resin film 3 is peeled off from the wafer lamination body 1. In this case, the adhesion strength of the adhesive agent 4, which is used for the present embodiment, with respect to the resin film 4 is higher than the adhesion strength of the adhesive agent 4 with respect to the wafer 2. Therefore, the resin film 3 can be peeled off without leaving the adhesive agent 4 on the wafer 2.

As shown in FIG. 2, when the resin film 3 is peeled off from the wafer lamination body 1, the wafer lamination body 1 is set upside down and the resin film 3 is peeled off by using the peeling method as follows. An elastic restoring force F generated in a curved portion, which is a starting point of peeling the resin film 3, is acted on the wafer 2 when the resin film 3 is bent back into substantially a U-shape. Due to the foregoing, the wafer 2 is prevented from being curved upward and the resin film 3 can be easily peeled off from the wafer 2.

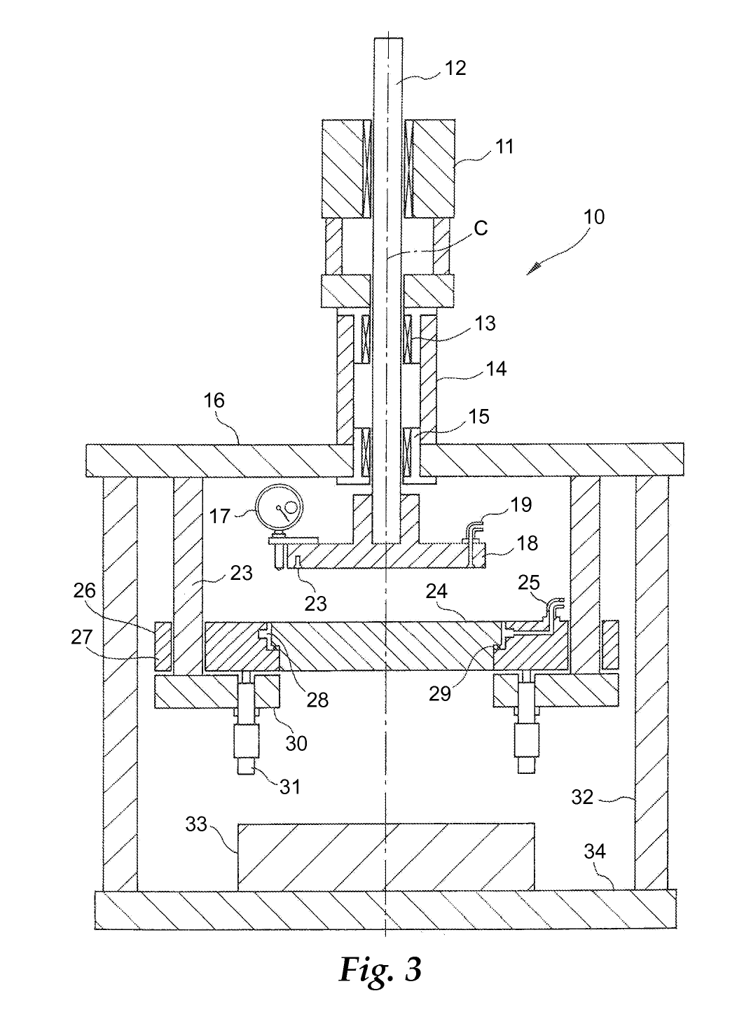

Next, an embodiment of the manufacturing device of manufacturing the above wafer lamination body 1 will be explained below. As shown in FIG. 3, the manufacturing device 10 is designed such that the upper suction table (the wafer suction table) 18 and the lower suction table (the first layer suction table) 26 are arranged being capable of vertically moving in a housing including the upper base 16 and the lower base 30 which are supported by three or more supports 21. The upper suction table 18 and the lower suction table 26 are arranged being opposed to each other so that the central shaft C can be on the same axis. On the lower side of the lower suction table 26, the UV irradiation source 33 for irradiating ultraviolet rays so as to harden the liquid adhesive agent 4 is arranged. In order to uniformly disperse a load given in the vertical direction of the housing structure, distances from the supports 21 to the moving shaft of the upper suction table 18 are all the same and the supports 21 are arranged at regular intervals. In this connection, the manufacturing device 10 of the present embodiment includes a UV irradiation source 33 which is a hardening means for hardening the liquid adhesive agent 4. However, it should be noted that the hardening means for hardening the adhesive agent 4 is not limited to the above UV irradiation source 33 in the present disclosure. It is possible to use a heat source instead of the UV irradiation source 33.

In order for the upper suction table 18 to be moved in the perpendicular direction with respect to the reference face of the upper base 16, the rigid shaft 12 to support the upper suction table 18 is moved upward and downward along the cylindrical member 14 in which two linear bushes 13, 15 are enclosed. At this time, in order to enhance the accuracy of the movement in the perpendicular direction of the shaft 12, it is important that the two linear bushes 13, 15 are attached at positions distant from each other.

Examples of the actuator 11 of the shaft 12 for supporting the upper suction table 18 are: an air cylinder, a hydraulic cylinder and a linear motor head. However, from the viewpoint of maintaining the accuracy of the stopping position and enhancing the stopping performance, it is preferable to use a linear head driven by a servo motor or a stepping motor. The maximum thrust of the actuator 11 depends upon the size of the wafer to be actually stuck, the resistance load of the manufacturing device and the viscosity of the adhesive agent. It is preferable that the thrust of the actuator 11 can be generated so that the pressure of about 0.1 to 1.0 kg/cm² can be given. In any case, it is important that the shaft 12 is not moved at the stoppage time even when an external force is given. However, it is impossible to evade the occurrence of a small spring-back phenomenon. Therefore, it is necessary to provide a mechanism for watching an absolute gap distance between the upper suction table 18 and the lower suction table 26 at all times. It is effective to control the absolute gap as follows. For example, the linear gauge 17 is attached to a side of the upper suction table so that a forward end portion of the linear gauge 17 can be contacted with the transparent rigid body (flat plate) 24 of the lower suction table 26.

The upper suction table 18 includes a mechanism for holding the wafer 2. In order to maintain the flatness of the wafer 2 to be sucked, the flatness of the suction face is in the range ±5 μm. It is more preferable that the flatness of the suction face is in the range ±1 μm. Concerning the holding mechanism, it is possible to use a means of vacuum suction, adhesion or electrostatic suction. It is preferable to use a means of vacuum suction because it is simple. In the present disclosure, suction grooves 23 for vacuum suction are provided on the upper suction table 18. In order to facilitate a discharge of air at the time of sucking the wafer, surface irregularities of not more than several μm are provided on the suction face so that the flatness of the suction face can not be affected.

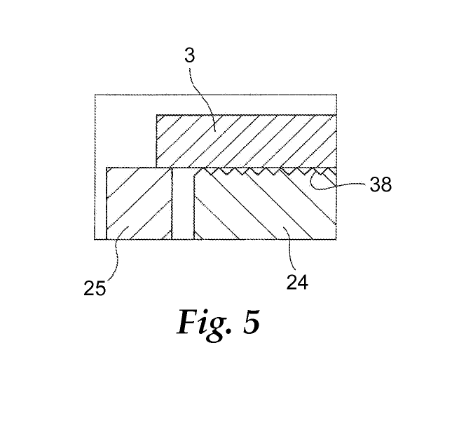

In order to suck the resin film 3 by vacuum, the lower suction table 26 includes suction grooves 28. In order to maintain the flatness of the resin film 3 to be sucked, the flatness of the suction face is in the range ±5 μm. It is preferable that the flatness of the suction face is in the range ±1 μm. In the same manner as that of the upper suction table 18, in order to facilitate a discharge of air from between the suction face and the resin film 3 to be sucked, surface irregularities of not more than several μm are provided on the rigid body 24 (shown in FIG. 5) so that the flatness of the suction face can not be affected. The surface irregularities 38 on the rigid body 24 can be formed by various methods. For example, blasting can be applied. In the case where the rigid body 24 is made of glass, the surface irregularities 38 are the same as those of ground glass. From the viewpoints of maintaining the visibility at the time of adhesion, suppressing the generation of deformation at the time of adhesion and making ultraviolet rays transmit at the time of hardening the liquid adhesive agent of the ultraviolet ray hardening type, it is preferable that a central portion of the lower suction table 26 is formed out of a transparent rigid body 24. Examples of the transparent rigid body 24 are: boric acid glass such as Pilex (registered brand name) or Tenpax (registered brand name); and quartz glass. In the case where only a portion of the lower suction table 26 is formed out of a transparent rigid body, it is preferable that three supporting points 29 are provided so that the generation of rattling can be prevented, that is, it is preferable to employ the three point supporting system.

From the viewpoint of controlling the parallelism between the suction faces of the upper suction table 18 and the lower suction table 26, it is possible to compose such a structure that the lower suction table 26 is not moved in the vertical direction and only an inclination angle of the suction surface is changed. A specific method of changing the inclination angle of the suction surface is that the lower base 30 is supported by three points of the micrometer head 31. When the three points of the micrometer head 31 are independently moved, an inclination angle of the lower suction table 26 can be changed.

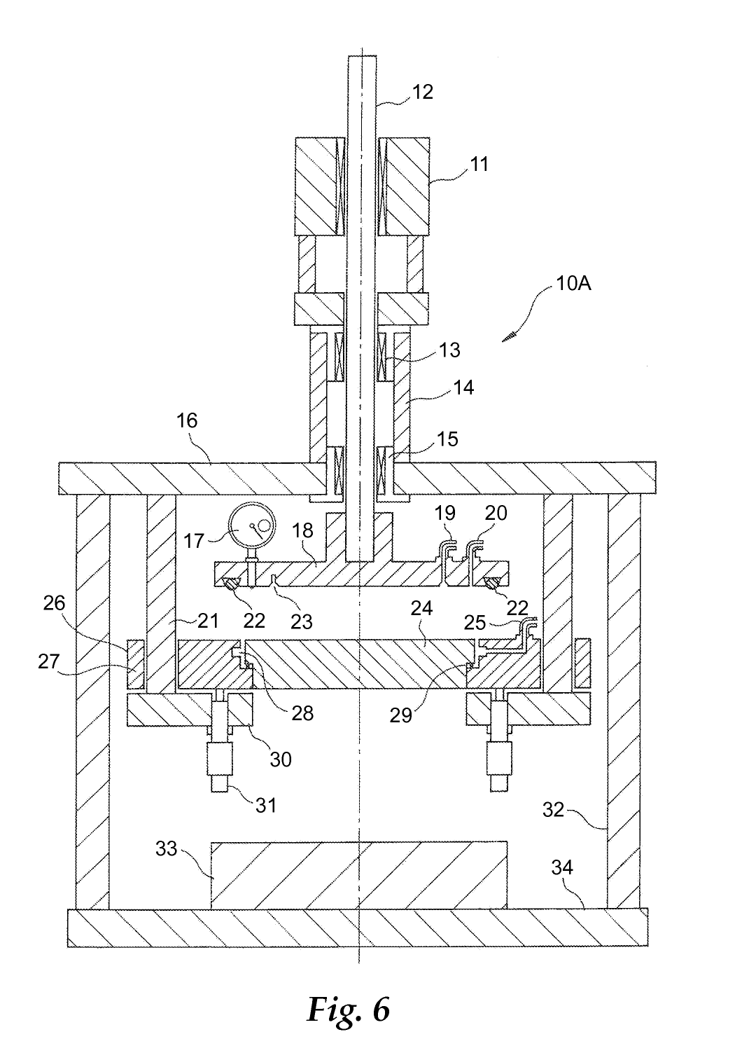

As a variation of the manufacturing device is shown in FIG. 6, it is possible to form a space between the upper suction table 18 and the lower suction table 26 into a vacuum atmosphere space. In this case, when O-ring 22, which is contacted with an opposing face of the lower suction table 26 and elastically deformed, is attached to an outer circumferential portion of an opposing face of the upper suction table 18, the space between the upper suction table 18 and the lower suction table 26 can be tightly closed and when the thus tightly closed space is decompressed, it is possible to maintain the space in the state of a vacuum atmosphere. Examples of the material of O-ring 22 are: nitrile rubber, fluorine rubber, silicon rubber and ethylene propylene rubber.

UV irradiation source 33 for irradiating ultraviolet rays to harden the liquid adhesive agent 4 is arranged right below the center of the lower base 30. Depending upon the type of the adhesive agent 4 to be used, the resin film 3 and the transmittance of the transparent rigid body 24 attached to the lower suction table 26, an irradiation intensity of UV irradiation source 33 is approximately determined at 50 to 100 mW/cm². Then, when ultraviolet rays are irradiated for 10 to 20 seconds, it is possible to irradiate energy of 500 to 2000 mJ/cm².

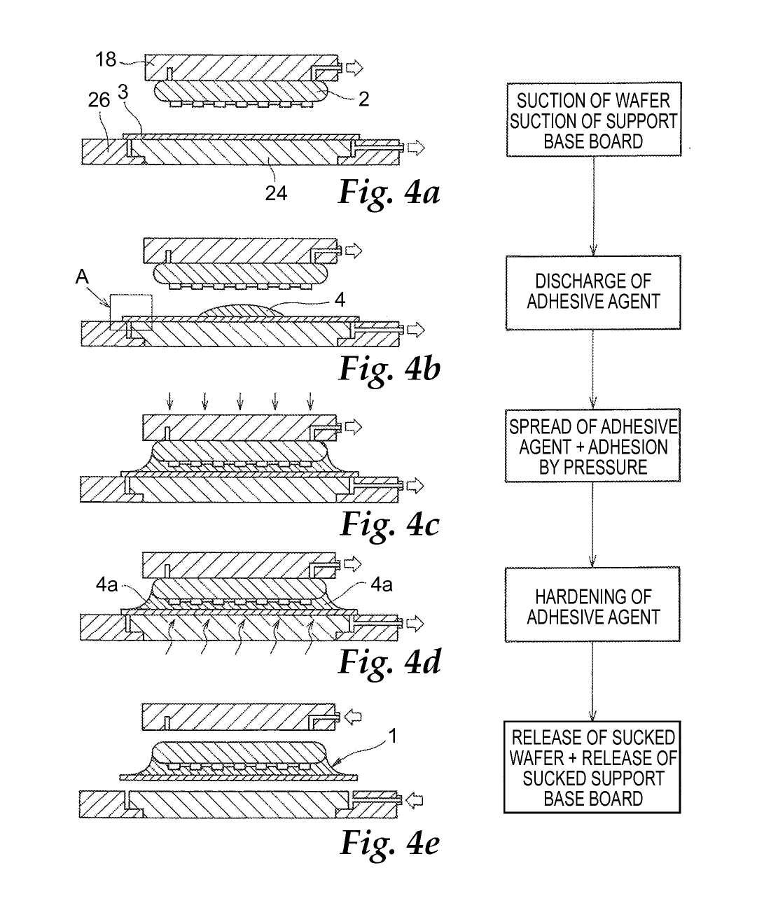

Next, referring to FIGS. 4(a) to 4(c), an exemplary method of manufacturing the wafer 1 will be explained below. This manufacturing method includes a step of sucking the wafer 2 onto the suction face of the upper suction table 18 by vacuum; a step of sucking the resin film 3 onto the suction face of the lower suction table 26 (the rigid body 24); a step of applying the liquid adhesive agent 4 onto the resin film 3; a step of pressurizing and spreading the liquid adhesive agent 4 after the wafer surface and the film surface have been contacted with each other while the parallelism between them is being maintained; a step of hardening the liquid adhesive agent 4 at the point of time when the adhesive agent thickness (the wafer lamination body thickness) has reached a predetermined value; and a step of taking out the wafer lamination body 1 which has been made to adhere.

In the step of sucking the wafer 2 onto the suction face of the upper suction table 18 shown in FIG. 4a, the wafer 2 is sucked to the upper suction table 18 by vacuum so that an adhesion face (an opposing face) of the wafer 2 can be directed downward. On the other hand, in the step of sucking the resin film 3 onto the suction face of the lower suction table 26, vacuum suction is executed so that an adhesion face (an opposing face) of the resin film 3 can be directed upward. It is preferable that the pressure at the time of vacuum suction is lower than 100 Pa.

Next, in the step of applying adhesive agent onto the resin film 3 of FIG. 4b, it is required that substantially no bubbles are mixed with the adhesive agent during application. If bubbles are mixed with the adhesive agent, thickness of the wafer laminated body 1 may become non-uniform, which may cause cracking or breaking (chipping) in wafer at the time of grinding the reverse surface of the wafer. In order to ensure uniform spreading of the applied adhesive agent and uniform formation of the resin projecting portion on the outer circumference of the adhesive agent, the liquid adhesive agent is applied nearly at the adhesion center of the wafer 2. In order to control the resin projecting portion 4a on the outer circumference of the liquid adhesive agent, it is desired to apply proper amount of adhesive agent taking into account the target thickness (thickness of the laminated body) of the adhesive agent layer 4. Approximately 10% more than the amount required for filling the space between the wafer 2 and the film 3 may be advantageously used to form the resin projecting portion 4a of the adhesive agent. Specifically, the amount W (g) of the applied adhesive agent is given by the formula W (g)=1.1×(π×R²×t×G), where R (cm) is the radius of the wafer, t (cm) is the thickness of the adhesive agent, and G (g/cm³) is the density of the adhesive agent.

Then, the upper suction table 18 of FIG. 4c is slowly lowered, and when the wafer 2 comes into contact with the adhesive agent on the film 3, the actuator 11 is operated to pressurize the adhesive agent between the wafer 2 and the film 3. The pressure depends on the viscosity of the adhesive agent, the target thickness, and the like, but may be approximately in the range of 0.1-1.0 kg/cm². While this state of pressurization is maintained, the liquid adhesive agent is spread all over the face of the wafer 2 until the desired thickness of the adhesive agent layer 4 is obtained, and the adhesive agent between the wafer 2 and the film 3 is squeezed out from the space between the wafer 2 and the film 3 to form the resin projecting portion 4a on the outer circumferential side of the wafer 2 (wafer laminated body 1). When the resin projecting portion 4a is formed, and desired thickness of the adhesive agent layer 4 is reached, ultraviolet ray from the UV irradiation source is irradiated to the adhesive agent to harden the adhesive agent.

The resin projecting portion 4a is a portion projecting outward from the outer circumference of the wafer 2. By forming this resin projecting portion 4a, the outer circumference of the wafer 2 can be adhered to the film 3 without producing gap therebetween. Thus, occurrence of a portion in the outer circumference of the wafer 2 that is not adhered to the film 3 is avoided, so that stress concentration to such a non-adhered portion leading to occurrence of chipping during grinding of the reverse surface can be prevented. Because such chipping is more likely to be produced in the case of thinner wafer 2, forming the resin projecting portion is very effective to prevent the occurrence of chipping. The form of the resin projecting portion 4a formed on the outer circumference of the wafer 2 may be varied depending on the viscosity and the type of the adhesive agent, the wettability relative to the wafer 2 and the film 3. The resin projecting portion 4a may be formed as concave type (fillet-shape type) 4a₁ or as convex type 4a₂. The resin projecting portion 4a is of concave type 4a₁.

The resin projecting portion 4a is formed by pressurizing a predetermined amount of adhesive agent between the wafer 2 and the film 3 to force the adhesive agent to be squeezed out from the wafer 2, and does not come into contact with the suction face of the upper suction table 18 that sucks the wafer 2. This is because the upper suction table 18 is situated above, and because the amount of applied adhesive agent is adjusted to proper amount. Since the film 3 is formed in size a little larger than that of the wafer 2, it can receive the adhesive agent squeezed out from the space between the wafer 2 and the film 3, and can thus form a resin projecting portion 4a in the shape of a skirt. Thus, the construction of the device 10 for manufacturing the wafer laminated body in which the upper suction table 18 for sucking the wafer is situated above and the lower suction table 26 for sucking the film 3 is situated below is a preferred arrangement for forming the resin projecting portion 4a.

The wafer laminated body 1 as an intermediate product is manufactured in the manner as described above. The wafer laminated body 1 is then transferred to the step of grinding the reverse surface, in which the wafer 2 is ground to a desired thickness. After grinding of the reverse surface has been completed, the resin film 3 together with the adhesive agent layer 4 is peeled off from the wafer laminated body 1 in accordance with the method of the present disclosure to obtain the wafer 2 of desired thickness.

In the manufacturing method of manufacturing the wafer lamination body 1 described above, even when substantially no bubbles are mixed with the adhesive agent 4 at time of applying the adhesive agent 4 onto the film 3, bubbles may be mixed with the adhesive agent 4 in the process of spreading the adhesive agent 4 between the wafer 2 and the film 3. For example, in the case where the aspect ratio of the circuit body provided on the surface of the wafer is high or in the case where a circuit body, which is a so-called high bump, is formed, there is a possibility that a large number of bubbles are mixed with the adhesive agent 4. If the bubbles are mixed with the adhesive agent 4, the wafer 2 will likely be cracked and broken. Therefore, a space between the wafer 2 and the film 3 is put in a vacuum atmosphere so that no bubbles can be mixed in the adhesive agent 4 at the time of spreading the adhesive agent 4 between the wafer 2 and the film 3. This method is shown in FIG. 6. When this method is used, it is also possible to defoam bubbles, if present, which are mixed with the adhesive agent 4 before the wafer 2 and the film 3 are made to adhere to each other.

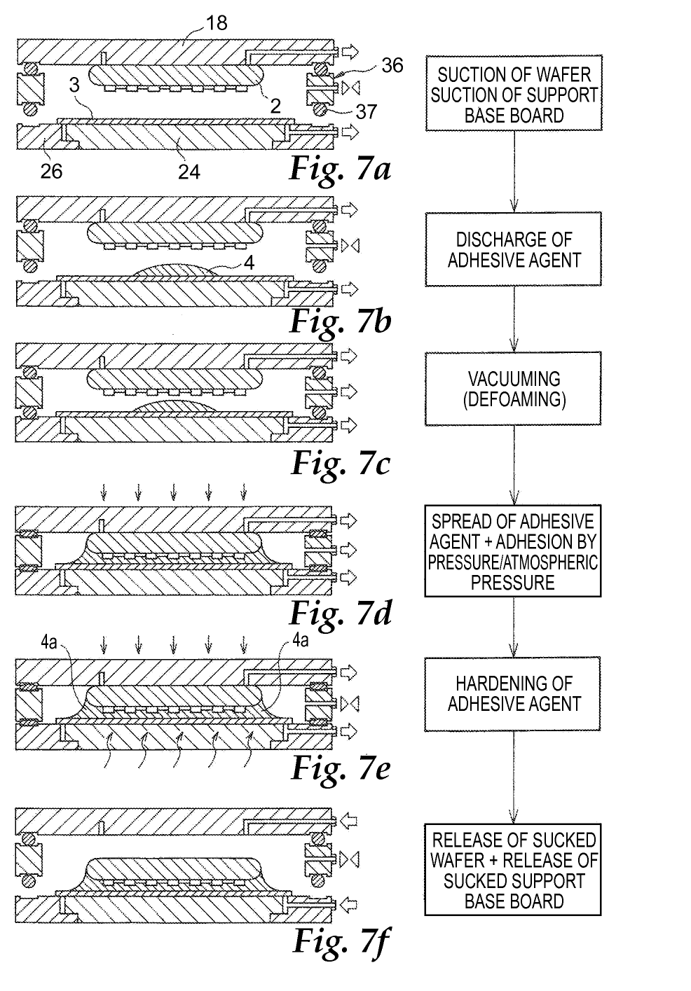

The variation of the manufacturing method of the present disclosure shown in FIGS. 7a to 7e can include a step of making an atmosphere between the wafer 2 and the film 3 into a vacuum state so that no bubbles can be mixed with the adhesive agent 4 and bubbles mixed with the adhesive agent 4 can be defoamed. The step of defoaming the bubbles shown in FIG. 7c can be executed in the step in which the liquid adhesive agent 4 is pressurized and spread after the wafer 2 and the film 3 have been contacted with each other. In order to execute the defoaming step, it is necessary that the wafer 2 and the film 3 are made to adhere to each other in a vacuum atmosphere. In this case, the vacuum atmosphere can be made in such a manner that a vacuum tank is provided in the housing structure of the manufacturing device 10A or O-ring 22 is attached to the outer circumferential portion of the opposing face of the upper suction table 18 as shown in FIG. 6 so that a space between the upper suction table 18 and the lower suction table 26 can be tightly closed and decompressed.

A method of defoaming the bubbles mixed with the adhesive agent 4 will be specifically explained below. The wafer 2 sucked onto the upper suction table 18 is made to come close to the film 3 sucked onto the lower suction table 26. When O-ring 37, which is protruded from the defoaming jig 36 located at a position between the upper suction table 18 and the lower suction table 26, comes into contact with the lower suction table 26, a motion of the actuator 11 or the shaft 12 is completely stopped. At this point of time, the adhesive agent 4 on the film 3 does not come into contact with the wafer 2. Next, a decompressing device (not shown) is operated and a space between the wafer 2 and the film 3 is decompressed through the vacuum valve 20 (shown in FIG. 6).

When defoaming has been completed, the actuator 11 or the shaft 12 is operated so that pressure can be gradually given. Therefore, the upper suction table 18 is given the pressure generated by the actuator 11 and the atmospheric pressure. When this state of pressurization is maintained and the adhesive agent 4 spreads all over the face of the wafer 2 and further the adhesive agent thickness has reached a predetermined value, the vacuum valve 20 is closed. Under the condition of decompression, ultraviolet rays are irradiated and the adhesive agent 4 is hardened. After the adhesive agent 4 has been hardened, a space between the upper suction table 18 and the lower suction table 26 is open to the atmosphere and the film lamination body 1 is taken out. After a reverse face of the wafer 2 of the film lamination body 1 has been ground, the resin film 3 is peeled off from the film lamination body 1 by the 180° peeling method shown in FIG. 2. In this way, the wafer 2, the thickness of which is a desired value, can be obtained.

In this connection, it should be noted that the present disclosure is not limited to the above specific embodiment and variations can be made. In the wafer lamination body 1 of the present embodiment, the adhesive layer 4 is a single layer, however, the adhesive agent layer 4 can be formed into a multi-layer structure. For example, before the wafer 2 is sucked onto the upper suction table 18, a surface of the wafer can be subjected to a surface preparation by an adhesive agent used for the surface preparation, the quality of which is substantially the same as that of the adhesive agent 4. In this case, the adhesive agent 4 layer is composed of 2-layer structure. The 2-layer structure of the adhesive agent 4 layer is advantageous especially when the bump height is large. When this structure is used, processing is executed so that substantially no gap can be formed between the adhesive agent for surface preparation and the wafer 2, that is, so that no bubbles can be left. Accordingly, the generation of cracks on the wafer 2 can be effectively prevented. In the case where the adhesive agent 4 layer is composed of two layers, in order to prevent the deterioration of the adhesion property on the interface, it is preferable that the adhesion characteristics of the adhesive agents composing the layers are the same. The tensile elastic modulus at the room temperature 23° C. of each layer is 1.0 to 9.0×10⁸ Pa and the breaking elongation is 5 to 50%.

1. A method of manufacturing a wafer laminated body, said wafer laminated body comprising:
a) a wafer;
b) a support body for supporting said wafer;
c) an adhesive agent layer for adhering said wafer and said support body to each other; and,
d) a resin projecting portion formed on an outer circumference of said wafer;
said method comprising the steps of:
(1) sucking said wafer onto a wafer suction table situated above, sucking said support body onto a support body suction table situated below, and arranging said wafer and said support body in opposition to each other in a vertical direction;
(2) applying a liquid adhesive resin to an opposing face of said support body opposed to said wafer for forming said adhesive agent layer;
(3) causing said wafer and said support body to approach each other while maintaining parallelism between said wafer and said support body, and applying pressure to said adhesive resin interposed between said wafer and said support body and spreading said adhesive resin to thereby fill a space between said wafer and said support body with said adhesive resin, and to form said resin projecting portion on said outer circumference of said wafer; and
(4) irradiating said adhesive resin with ultraviolet ray, when said wafer laminated body reaches to a predetermined thickness, to thereby harden said adhesive resin and form said adhesive agent layer.

2. A method of manufacturing a wafer laminated body according to claim 1, wherein a vacuum atmosphere is formed in said space between said wafer and said support body, and with said adhesive resin interposed therebetween, said adhesive resin is pressurized and spread to thereby fill the space between said wafer and said support body with said adhesive resin, and to form said resin projecting portion on said outer circumference of said wafer.

3. A method of manufacturing a wafer laminated body according to claim 1, wherein said support body is sucked onto said support body suction table while defoaming bubbles from said space between said support body suction table having surface irregularities on a suction face and said support body.

4. A method of manufacturing a wafer laminated body according to claim 1, wherein, before said wafer is sucked onto said wafer suction table, said opposing face of said wafer is coated with a primer layer of adhesive resin of property generally comparable to said adhesive agent layer.

5. A method of manufacturing a wafer laminated body according to claim 1, wherein said support body is a resin film that is 30-200 μm in thickness and has a bending elastic modulus of not less than 1000 MPa and not more than 10000 MPa at room temperature of 23° C.

6. A method of manufacturing a wafer laminated body according to claim 1, wherein said support body has a dimension larger than an outer diameter of said wafer so as to be able to receive said adhesive resin squeezed out from said space between said wafer and said support body.

7. A method of manufacturing a wafer laminated body according to claim 1, wherein said adhesive agent layer is a layer of UV hardening type adhesive resin which has a viscosity of not less than 100 cP and lower than 10000 cP in the liquid state at 23° C. before hardening.

8. A manufacturing device for manufacturing a wafer laminated body comprising:
a wafer suction table for sucking a wafer;
a support body suction table arranged under a lower side of and in opposition to said wafer suction table, for vacuum-sucking of a support body that is to be attached to said wafer via a liquid adhesive resin; and
a UV irradiation source for irradiating said adhesive resin with ultraviolet ray for hardening said adhesive resin;
wherein said support body suction table can transmit said ultraviolet ray and has surface irregularities in order to be able to suck said support body.

9. A manufacturing device for manufacturing a wafer laminated body according to claim 8, wherein said support body suction table is a glass table having irregularities on a suction face.

10. A wafer laminated body that is made by the method according to claim 1.

11. A wafer laminated body comprising:
a wafer;
a support body that supports said wafer;
an adhesive agent layer that adheres said wafer to said support body; and
a resin projecting portion formed on an outer circumference of said wafer.

12. A method of peeling a support body in which, after reverse surface of the wafer laminated body according to claim 11 has been ground to reduce the thickness of said wafer to a predetermined thickness, said support body together with said adhesive agent layer is peeled off from said wafer laminated body, wherein said support body together with said adhesive agent layer is peeled off from said wafer laminated body in such a manner that, when said support body is folded back in substantially a U-shape, said wafer is not bent.

13. A method of manufacturing a wafer comprising:
providing said wafer laminated body according to claim 11;
grinding said wafer to a desired thickness; and
after completion of grinding, peeling off said support body together with said adhesive agent layer from said wafer laminated body.
